(19) United States
(12) Patent Application Publication
(10) Pub. No.: US 2019/0244172 A1
(43) Pub. Date: Aug. 8, 2019

(54) ENHANCED CARGO DELIVERY

(71) Applicant: Ford Motor Company, Dearborn, MI (US)

(72) Inventors: Leonard Eber CARRIER, Dearborn, MI (US); Zachary KONCHAN, Westland, MI (US)

(21) Appl. No.: 16/339,109

(22) PCT Filed: Oct. 11, 2016
(86) PCT No.: PCT/US2016/056358

§ 371 Date: Apr. 3, 2019

(51) Int. Cl. G06Q 10/08

(52) U.S. Cl. CPC G06Q 10/08355

(57) ABSTRACT

A request to collect and deliver a plurality of items of cargo is received. One or more predetermined classes for each item are identified. At least one source to provide the items is identified based at least in part on the classes. A route is determined to the source and to a delivery location for the items. One or more vehicle subsystems are actuated to move a vehicle along the route to the source and to the delivery location.

### BACKGROUND

Delivery vehicles typically deliver items of cargo to locations in a city. However, the delivery vehicles may follow predetermined routes and therefore lack ability to follow a most efficient route and/or to accommodate a modified route. Furthermore, the delivery vehicles may lack a configuration to deliver various types of cargo or more than one type of cargo. For example, systems are lacking for coordinating delivery vehicles to deliver items to cargo recipients based on specified inputs from the recipients.

### BRIEF DESCRIPTION OF THE DRAWINGS

FIG. 1 is a block diagram of an example cargo delivery system.

FIG. 2 illustrates an example list of items of cargo to be delivered to a cargo recipient.

FIG. 3 illustrates an example of identifying items of cargo with sources for the items.

FIG. 4 illustrates an example route to move a vehicle to one or more source locations to collect the items.

FIG. 5 illustrates a change in the route.

FIG. 6 is a block diagram of an example process for collecting and delivering the items of cargo.

### DETAILED DESCRIPTION

A cargo delivery system computer receives input requesting collection and delivery of a plurality of items of cargo. The computer classifies the items according to one or more predetermined classes. At least one source is identified to receive the items based at least in part on the classes. A route is determined to the source and to a delivery location for the items. One or more vehicle subsystems is actuated to move a vehicle along the route to the source and to the delivery location.

By classifying the items of cargo into classes, the computer can identify sources that carry items of cargo satisfactory to the user based on one or more classes determined for items in a request. That is, the classes allow the user to specify the items of cargo and find sources that carry the items. The computer can look for sources in specific geographic locations, e.g., within a predetermined distance from a delivery location (e.g., 10 miles) that carry items of the same classes as those specified by the user. Furthermore, using a user vehicle to deliver the items allows the user to receive the items at a time and location convenient to the user, rather than relying on the predetermined routes and/or schedules of conventional delivery vehicles.

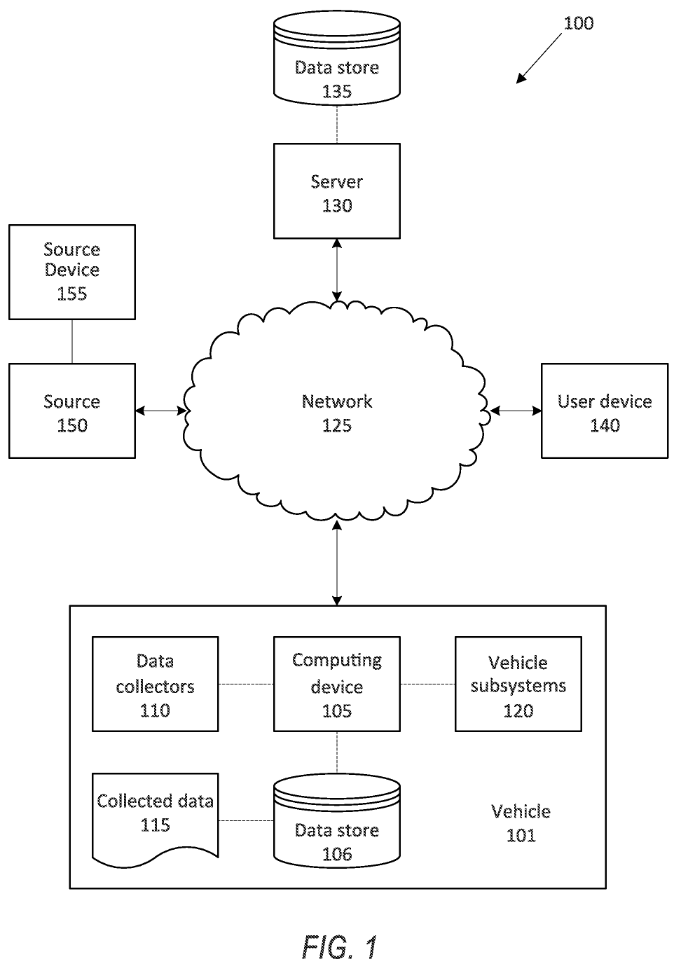

FIG. 1 illustrates a system 100 for delivering items of cargo. A computing device 105 in a vehicle 101 is programmed to receive collected data 115 from one or more data collectors 110. For example, vehicle 101 data 115 may include a location of the vehicle 101, a location of a target, etc. Location data may be in a known form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computing device 105 is generally programmed for communications on a vehicle 101 network or communications bus, as is known. Via the network, bus, and/or other wired or wireless mechanisms (e.g., a wired or wireless local area network in the vehicle 101), the computing device 105 may transmit messages to various devices in a vehicle 101 and/or receive messages from the various devices, e.g., controllers, actuators, data collectors, etc., including data collectors 110. Alternatively or additionally, in cases where the computing device 105 actually comprises multiple devices, the vehicle network or bus may be used for communications between devices represented as the computing device 105 in this disclosure. In addition, the computing device 105 may be programmed for communicating with a network 125, which, as described below, may include various wired and/or wireless networking technologies, e.g., cellular, Bluetooth®, wired and/or wireless packet networks, etc.

The data store 106 may be of a known type, e.g., hard disk drives, solid state drives, servers, or any volatile or non-volatile media. The data store 106 may store the collected data 115 sent from the data collectors 110.

Data collectors 110 may include a variety of devices. For example, as is known, various controllers in a vehicle 101 may operate as data collectors 110 to provide data 115 via the vehicle 101 network or bus, e.g., data 115 relating to vehicle speed, acceleration, position, system and/or component status, etc. Further, other data collectors 110 could include sensors such as cameras, motion detectors, short range radar, long range radar, LIDAR, and/or ultrasonic transducers, etc., i.e., data collectors 110 to provide data 115 for evaluating a location of a target, projecting a path of a parking maneuver, evaluating a location of a roadway lane, etc. The data collectors 110 may further include weight sensors that detect a change in a weight applied to a seat, a trunk, a floor, etc.

Collected data 115 may include a variety of data collected in a vehicle 101. Examples of collected data 115 are provided above, and moreover, data 115 are generally collected using one or more data collectors 110, and may additionally include data calculated therefrom in the computing device 105, and/or at the server 130. In general, collected data 115 may include any data that may be gathered by the data collectors 110 and/or computed from such data.

The vehicle 101 may include a plurality of subsystems 120. The subsystems 120 control vehicle 101 components, e.g., a vehicle seat, mirror, tiltable and/or telescoping steering wheel, etc. The subsystems 120 include, e.g., a steering subsystem, a propulsion subsystem, a brake subsystem, a park assist subsystem, an adaptive cruise control subsystem, etc. The computing device 105 may actuate the subsystems 120 to control the vehicle 101 components, e.g., to stop the vehicle 101, to avoid targets, etc. The computing device 105 may be programmed to operate some or all of the subsystems 120 with limited or no input from a human operator, i.e., the computing device 105 may be programmed to operate the subsystems 120 as a virtual operator. When the computing device 105 operates the subsystems 120 as a virtual operator, the computing device 105 does not use input from the human operator with respect to subsystems 120 selected for control by the virtual operator, which provides instructions, e.g., via a vehicle 101 communications bus and/or to electronic control units (ECUs) as are known, to actuate vehicle 101 components, e.g., to apply brakes, change a steering wheel angle, etc. For example, if the human operator attempts to turn a steering wheel during virtual operator steering operation, the computing device 105 may ignore the movement of the steering wheel and steer the vehicle 101 according to its programming.

When the virtual operator operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the virtual operator, i.e., vehicle computing device 105, under substantially all circumstances.

The system 100 may further include a network 125 connected to a server 130 and a data store 135. The computing device 105 may further be programmed to communicate with one or more remote sites such as the server 130, via the network 125, such remote site possibly including a data store 135. The network 125 represents one or more mechanisms by which a computing device 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The system 100 may include a user device 140. The user device 140 may be any one of a variety of computing devices including a processor and a memory, e.g., a smartphone, a tablet, a personal digital assistant, etc. The user device 140 may use the network 125 to communicate with the computing device 105.

The system 100 includes a source 150 of items. The source 150 provides items that the vehicle 101 collects and delivers to a user. The source 150 includes a source device 155. The source device 155 may be any one of a variety of computing devices including a processor and a memory, e.g., a smartphone, a tablet, a personal digital assistant, etc. The server 130 may communicate with the source device 155 over the network 125.

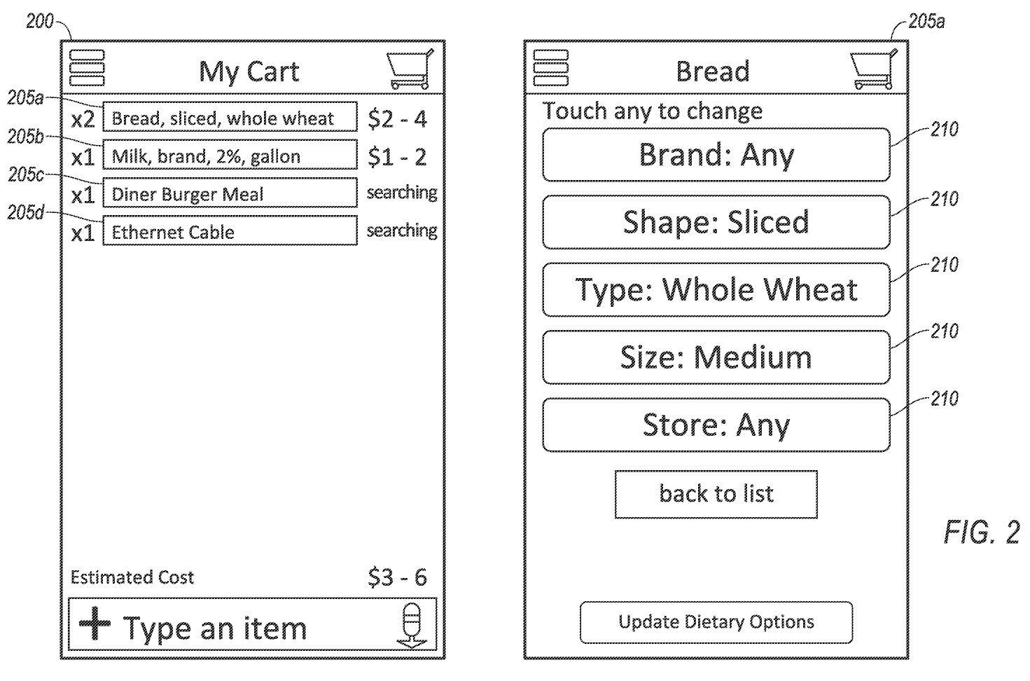

FIG. 2 illustrates an example cargo list 200 on a display of the user device 140. The cargo list 200 includes a plurality of items of cargo 205. A user selects the items of cargo 205 to be delivered. The example list 200 of FIG. 2 includes four items 205: a loaf of bread 205a, a gallon of milk 205b, a burger combo meal 205c, and an Ethernet cable 205d.

Each of the items 205 may have more than one descriptor 210. The descriptors 210 allow the user to specify the items 205 on the list 200. For example, as shown in FIG. 2, the item 205a is bread, and the descriptors 210 include a brand, an ingredient type, a size, and a specific source. Thus, the user can select the specificity of the item 205 to be collected. For example, in FIG. 2, the user can set the “brand” descriptor 210 to “any,” indicating that any brand of bread is acceptable, and can set the “shape” descriptor 210 to “sliced,” indicating that the server 130 should search for sliced bread rather than unsliced bread. Based on the selected descriptors 210, the server 130 can identify specific items 205 that match the descriptors 210.

The server 130 identifies at least one of a plurality of classes for each of the items 205. That is, the server data store 135 may include a predetermined look-up table indicating the classes associated with various items of cargo 205. The server 130 can be programmed to search the look-up table for the items 205 on the list 200 and identify the classes associated with each item 205. By identifying the classes of each of the items 205, the server 130 can identify one or more sources 150 that carry goods in the classes and from which the items 205 requested by the user can be obtained. The classes may include, e.g., groceries (including breads, meats, produce, etc.), clothing (e.g., shoes, suits, etc.), restaurants (e.g., fast casual, quick-service, diner, etc.), quality (e.g., luxury, discount, etc.), etc. The classes may be predetermined and stored in the server data store 135.

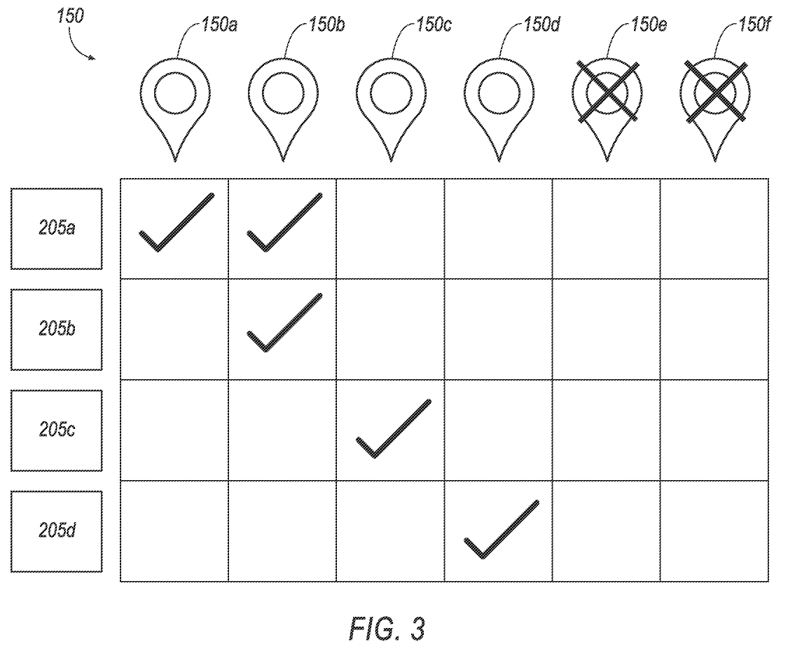

FIG. 3 illustrates the server 130 matching items 205 with one or more sources 150 based on the classes. Upon receiving the list 200 from the user, the server 130 identifies the classes associated with the items 205 on the list 200. The server 130 can search for sources 150 with classes that match the classes of the items 205. For example, as shown in FIG. 3, the server 130 may search for sources 150 for four items 205a, 205b, 205c, 205d. As shown in Table 1 below, the items 205a-205d each belong to a specific class. The item 205a belongs to the “bread” class, the item 205b belongs to the “milk” class, the item 205c belongs to the “diner” class, and item 205d belongs to the “computer” class.

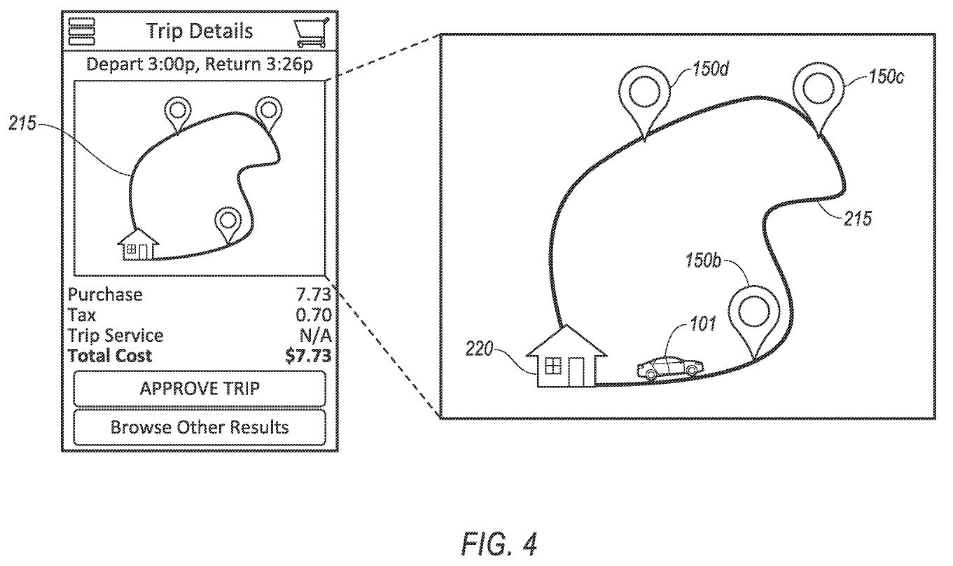

Each of the sources 150 has goods belonging to one or more of the classes. FIG. 4 shows six example sources 150a, 150b, 150c, 150d, 150e, 150f. The server 130 searches the sources 150a-150f for classes corresponding to the items 205a-205d. Table 1 below illustrates the classes associated with the items 205a-205d and the sources 150a-150f that match each item 205a-205d:

TABLE 1

| Source | 150a | 150b | 150c | 150d | 150e | 150f |
|---|---|---|---|---|---|---|
| Class | Bread | Bread | Diner | TV | Shoes | Shampoo |
| | Cake | Milk | Fast Casual | Computer | Luxury | Gel |
| | Cookies | Meat | | | Suits | Hair Spray |
| Item | | | | | | |
| 205a | x | x | | | | |
| 205b | | x | | | | |
| 205c | | | x | | | |
| 205d | | | | x | | |

As shown in Table 1, the item 205a, having the “bread” class, can be found at the sources 150a, 150b, which each carry items including the “bread” class. For example, the source 150a may be a bakery, and the source 150b may be a grocery store. Thus, the server 130 determines that the sources 150a and 150b should be considered. In another example, the item 205b, having the “milk” class, can be found at the source 150b, which carries items including the “milk” class. Thus, the server 130 may determine to go to the source 150b, which carries both items 205a, 205b, rather than to the source 150a, which only carries the item 205a. The server 130 can further determine that the item 205c, which is in the “diner” class, can be collected only at the source 150c, e.g., a diner. Furthermore, the server 130 can determine that one or more sources 150 do not carry items in the classes of the items 205a-205d. For example, the source 150e does not list items in the “bread,” “milk,” “diner,” or “computer” classes, so the server 130 ignores the source 150e. In another example, the source 150f also does not list items in any of the classes of the items 205a-205d, so the server 130 ignores the source 150f. Thus, in the example of FIG. 3 and Table 1, the server 130 considers the sources 150a-150d and determines the sources 150a-150d to collect the items 205a-205d. The server 130 can determine which ones of the sources 150a-150d to collect the items 205a-205d based on, e.g., proximity to the location of the vehicle 101, the shortest route to the sources 150a-150d, etc. For example, because the source 150b carries both items in the “bread” class and items in the “milk” class, the server 130 can determine to collect the items 205a-205b from the source 150b and not from the source 150a, which only carries items in the “bread” class.

FIG. 4 illustrates an example route 215 determined by the server 130 to collect the items 205 from the sources 150. The left panel of FIG. 4 shows the route 215 as displayed on a user device 140. The right panel of FIG. 4 is a magnified version of the route 215 as shown on the user device 150 illustrating the sources 150b-150d on the route 215. Upon determining the sources 150 that carry the items 205, the server 130 determines a route 215 from a location of the vehicle 101 to the sources 150 and to a delivery location 220. The user specifies the delivery location 220 for the vehicle 101 to deliver the items 205. Furthermore, the user can specify more than one delivery location 220 and identify items 205 to be delivered to each delivery location 220. As shown in FIG. 3 and Table 1 above, the server 130 determines the route 215 based on the sources 150b, 150c, and 150d. The server 130 determines the route 215 using known path-determination methods.

The server 130 sends the route 215 to the user device 140 and requests approval from the user, as shown in FIG. 4. The user may prefer different sources 150 than the sources 150 used to determine the route 215, or the user may prefer that the vehicle 101 go to the sources 150 on the route 215 in a different order than the route 215 specifies. If the user approves the route 215, the server 130 actuates vehicle subsystems 120 to move the vehicle 101 along the route 215. As described above, the vehicle 101 may be an autonomous vehicle 101, and the server 130 provides instructions to the computing device 105, acting as the virtual operator of the autonomous vehicle 101, to actuate the vehicle subsystems 120 to move along the route 215. Thus, the vehicle 101 can collect the items 205 without requiring the user to drive the vehicle 101 to the sources 150. If the user does not approve the route 215, the server 130 determines a new route 215 and sends the new route 215 to the user device 140 to request approval from the user.

The server 130 is programmed to provide instructions to the computing device 105 to move the vehicle 101 to the locations along the route 215 upon receipt of approval from the user. That is, the server 130 identifies the locations where the vehicle 101 must stop to pick up or deliver the items 205, i.e., each of the sources 150 and the delivery location 220. The server 130 actuates the propulsion, steering, and brake to move the vehicle 101 to the next location in the route 215 to pick up the items 205. Upon arriving at the source 150, the server 130 can determine that the items 205 were received by the vehicle 101 by collecting weight data 115 from a weight sensor 110. Each item 205 may have a predetermined weight stored in the server data store 135 that the server 130 compares to the data 115 from the weight sensor 110. If the weight sensor 110 detects a change in weight in, e.g., a vehicle 101 seat, trunk and/or floor, that is within a predetermined threshold of the weight of the items 205 to be received at the source 150, the server 130 can determine that the vehicle 101 has received the items 205. Upon receiving the items 205 at the source 150, the server 130 moves the vehicle 101 to the next source 150 to pick up more items 205. Upon picking up all of the items 205, the server 130 moves the vehicle 101 to the delivery location 220 to deliver the items 205.

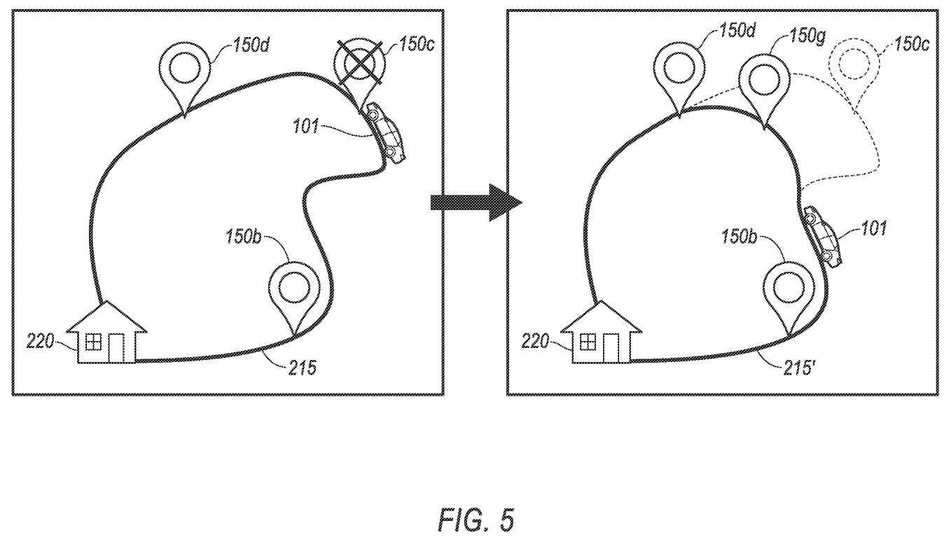

FIG. 5 illustrates a change in the route 215 when the vehicle 101 does not receive the items 205 at one of the sources 150. Upon arriving at one of the sources 150, the vehicle 101 waits to receive the items 205 from the source 150. The server 130 can send a notification to a source device 155, e.g., a phone, a tablet, a etc., at the source 150 to request a worker at the source 150 to place the items 205 in the vehicle 101. The notification can include an unlock code for the vehicle 101, e.g., an alphanumeric code.

However, the source 150 may be unable to provide the items 205 to the vehicle 101. For example, the source 150 may be out of stock of the specific item 205 requested by the user, may ignore the notification and/or omit to place the items 205 in the vehicle 101. The server 130 thus determines that the vehicle 101 has failed to pick up the items 205 from the source 150. The server 130 can instruct the vehicle 101 to wait for a predetermined period of time for the items 205, e.g., 10 minutes. When the predetermined period of time elapses, the server 130 can determine that the vehicle 101 has failed to pick up the items 205. In the example of FIG. 5, the vehicle 101 is unable to receive the item 205c at the source 150c.

When the server 130 determines that the vehicle 101 has failed to pick up at least one of the items 205, the server 130 can determine a new route 215 with new sources 150. The server 130 can determine the new sources 150 based on the classes of items 205 at the sources 150. The server 130 then selects the new sources 150 and presents the new route 215 to the user requesting approval. If the user approves the new route 215, then the server 130 actuates one or more vehicle subsystems 120 to move the vehicle 101 along the new route 215. Otherwise, the server 130 continues to search for sources 150 and determines more routes 215 until the user approves of the route 215. In the example of FIG. 5, the server 130 identifies a new source 150g that carries the item 205c. The server 130 then determines a new route 215′ and sends the route 215′ to the user for approval. Here, the user has approved the new route 215′, and the server 130 instructs the computing device 105 to actuate the vehicle subsystems 120 to move the vehicle 101 to the new source 150g.

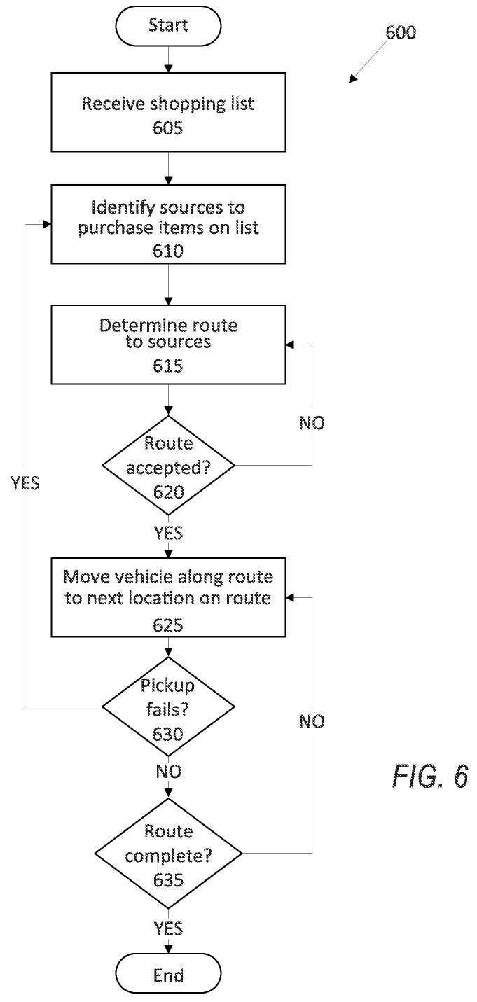

FIG. 6 illustrates an example process for delivering items of cargo 205. The process 600 begins in a block 605, in which the server 130 receives the list 200 with the items 205. As described above, the items 205 may be specified based on descriptors 210. The server 130 can classify each item 205 on the list 200 and determine the class or classes associated with each item 205, e.g., according to a stored look-up table, catalog, etc.

Next, in a block 610, the server 130 identifies sources 150 to retrieve the items 205 on the list 200. Based on the classes identified for each of the items 205 on the list 200, the server 130 searches for sources 150 that carry items of the same classes. The server 130 may identify sources 150 within a predetermined geographic location, e.g., within 10 miles from a user and/or a location of a vehicle 101.

Next, in a block 615, the server 130 determines a route 215 for the vehicle 101 to navigate to the sources 150. As described above, the route 215 starts at a location of the vehicle 101 and ends at the delivery location 220 specified by user input. As described above, the route 215 can include more than one specified delivery location 220. The server 130 can determine the route 215 using known route-planning algorithms.

Next, in a block 620, the server 130 sends the route 215 to the user device 140 and requests approval of the route 215 from the user. The user may disapprove of the route 215 if, for example, the route 215 moves the vehicle 101 into an area deemed unsafe by the user, the route 215 includes a source 150 that the user does not prefer, etc. If the user accepts the route 215, the process 600 continues in a block 625. Otherwise, the process 600 returns to the block 615 to determine another route 215.

In the block 625, the server 130 instructs the computing device 105 to operate the vehicle subsystems 120 to move the vehicle 101 to the next location on the route 215. That is, the server 130 identifies the next source 150 on the route 215 or, if all of the items 205 have been collected, the delivery location 220. The server 130 then instructs the computing device 105 to actuate the propulsion, steering, and brake to move the vehicle 101 to the next source 150 or the delivery location 220.

Next, in a block 630, the server 130 determines whether pickup of at least one of the items 205 has failed at the current source 150. For example, if the items 205 are not placed in the vehicle 101 within a predetermined period of time, e.g., 10 minutes, the server 130 determines that pickup of the items 205 at the source 150 has failed. If the vehicle 101 has failed to receive at least one of the items 205, the process 600 returns to the block 610 to identify sources 150 to collect the items 205 not received at the current source 150. Otherwise, the process 600 continues in a block 635.

In the block 635, the server 130 determines whether the route 215 is complete. For example, if the server 130 determines that the vehicle 101 has received all of the items 205 and moved to the delivery location 220, the server 130 can determine that the route 215 is complete. In another example, if the server 130 determines that the route 215 has at least one more source 150 to collect items 205, the server 130 can determine that the route 215 is not complete. If the server 130 determines that the route 215 is not complete, the process 600 returns to the block 625 to move to the next location on the route 215. Otherwise, the process 600 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices 105, 145, 155 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 600, one or more of the steps could be omitted, or the steps could be executed in a different order than shown in FIG. 6. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising a computer including a processor and a memory, the memory storing instructions executable by the computer to:
receive a request to collect and deliver a plurality of items of cargo;
identify one or more predetermined classes for each item;
identify at least one source to provide the items based at least in part on the classes;
determine a route to the source and to a delivery location for the items; and
actuate one or more vehicle subsystems to move a vehicle along the route to the source and to the delivery location.

2. The system of claim 1, wherein the instructions further include instructions to send the route to a user and to move the vehicle upon approval of the route by the user.

3. The system of claim 1, wherein the instructions further include instructions to determine a new route including at least one new source when the items are not received at the source on the route.

4. The system of claim 3, wherein the instructions further include instructions to request approval from a user for the new route and to actuate one or more vehicle subsystems to move the vehicle along the new route upon receipt of approval.

5. The system of claim 1, wherein the instructions further include instructions to wait at the source for a predetermined period of time to receive the items.

6. The system of claim 5, wherein the instructions further include instructions to identify at least one new source when the items are not received after the predetermined period of time.

7. The system of claim 1, wherein the instructions further include instructions to determine that the items were received at the source when a weight sensor detects a weight within a predetermined threshold of a predetermined weight of the items.

8. The system of claim 1, wherein the instructions further include instructions to send a notification to a source device to load the items in the vehicle.

9. The system of claim 1, wherein the request includes a plurality of delivery locations.

10. The system of claim 1, wherein each of the sources is assigned at least one of the classes.

11. A method, comprising:
receiving a request to collect and deliver a plurality of items of cargo;
identifying one or more predetermined classes for each item;
identifying at least one source to provide the items based at least in part on the classes;
determine a route to the source and to a delivery location for the items; and
actuate one or more vehicle subsystems to move a vehicle along the route to the source and to the delivery location.

12. The method of claim 11, further comprising sending the route to a user and to move the vehicle upon approval of the route by the user.

13. The method of claim 11, further comprising determining a new route including at least one new source when the items are not received at the source on the route.

14. The method of claim 13, further comprising requesting approval from a user for the new route and to actuate one or more vehicle subsystems to move the vehicle along the new route upon receipt of approval.

15. The method of claim 11, further comprising waiting at the source for a predetermined period of time to receive the items.

16. The method of claim 15, further comprising identifying at least one new source when the items are not received after the predetermined period of time.

17. The method of claim 11, further comprising determining that the items were received at the source when a weight sensor detects a weight within a predetermined threshold of a predetermined weight of the items.

18. The method of claim 11, further comprising sending a notification to a source device to load the items in the vehicle.

19. The method of claim 11, wherein the request includes a plurality of delivery locations.

20. The method of claim 11, wherein each of the sources is assigned at least one of the classes.
